(19) United States
(12) Patent Application Publication
(10) Pub. No.: US 2014/0265072 A1
(43) Pub. Date: Sep. 18, 2014

(54) ELECTRONICALLY CONTROLLED DAMPING STRUCTURE IN FITNESS EQUIPMENT

(71) Applicant: Ciber Chiu, Changhua (TW)

(72) Inventor: Ciber Chiu, Changhua (TW)

(73) Assignee: FAMOSA CORP., Changhua (TW)

(21) Appl. No.: 13/846,903

(22) Filed: Mar. 18, 2013

(51) Int. Cl. F16F 1/04

(52) U.S. Cl. CPC F16F 1/041
USPC 267/140.2

(57) ABSTRACT

An electronically controlled damping structure in fitness equipment may include a base, an adjusting unit and a driving component. A passive component of the adjusting unit can move in a receiving space of the base by the driving component to adjust the distance between the passive component and a top unit to further adjust the resilient coefficient of a buffer unit. So, when the user is exercising on the fitness equipment, he/she does not have to adjust the damping manually to increase the practicability of the fitness equipment, and it is more convenient for the user to adjust the damping.

### FIELD OF THE INVENTION

The present invention relates to a damping structure in fitness equipment, and more particularly to an electrically controlled damping structure in fitness equipment.

### BACKGROUND OF THE INVENTION

People are busy in this modern society and do not spend time in exercise or shorten the time of exercise, which cause a significant harm to the human bodies. Many people are aware of this problem and start to work out in fitness centers where there are a lot of fitness equipment provided for people according to their preferences. Most fitness equipment has damping structure to generate resistance for the user to achieve the goal of exercising. However, the damping structure in the fitness equipment is manually adjusted and it is inconvenient for the user and the resistance cannot be precisely selected. Therefore, there remains a need for a new and improved damping structure which can be adjusted through an electrical manner.

### SUMMARY OF THE INVENTION

The problem the present invention wants to solve is the damping structure in the fitness equipment is manually adjusted and it is inconvenient for the user and the resistance cannot be precisely selected. Therefore, there remains a need for a new and improved damping structure which can be adjusted through an electrical manner.

To solve the problems presented above, the present invention provides an electronically controlled damping structure in fitness equipment including a base, an adjusting unit and a driving component. The base has a main body having a hollow body extending therefrom. A receiving space is formed inside the hollow body to communicate with the main body, and the front portion of the hollow body shrinks and forms a ring stopping portion corresponding to the receiving space. The adjusting unit at least has one top unit, a buffer unit and a passive component that is disposed orderly in the receiving space of the base. The front portion of the top unit is protruding from the opening of the receiving space and the front portion thereof can form a connecting portion. The rear end of the top unit is enlarging to have a restricting portion to form a restricting position with the ring stopping portion. The passive component has a through hole, and the receiving space of the base and the passive component are engaged through threads. The receiving space has an inner thread section from the main body to the middle section of the receiving space, and the passive component has an outer thread section corresponding to the receiving space. Also, a block is disposed between the passive component and the buffer unit and a through opening is formed at center portion of the block. The driving component is disposed at the main body of the base and a locking portion is disposed between the base and the driving component. The main body of the base can extend to form the locking portion, or one side of the driving component can extend to form the locking portion. A driving shaft is protruding from the driving component into the receiving space to link with the through hole of the passive component, so the passive component can be driven by the driving component to adjust the movement in the receiving space and form a restricting position. In one embodiment, the driving component is a motor and the driving shaft is not a tubular body, and the through hole of the passive component is a non-circular hole corresponding to the driving shaft. Therefore, the passive component can move in the receiving space using the driving component to further adjust the distance between the passive component and the top unit to achieve the goal of adjusting the resilient coefficient of the buffer unit. Namely, it achieves the goal of controlling the position of the adjusting components electrically and an electrically controlled damping structure in fitness equipment is obtained.

According to the embodiments described above, the present invention is advantageous because the damping can be adjusted electronically, so when the user is exercising on the fitness equipment, he/she does not have to adjust the damping manually to increase the practicability of the fitness equipment, and it is more convenient for the user to adjust the damping.

### BRIEF DESCRIPTION OF THE DRAWINGS

FIG. 1 illustrates a three-dimensional view of the present invention.

FIG. 2 illustrates an exploded view of the present invention.

FIG. 3 illustrates a sectional view of the present invention.

FIG. 4 illustrates a sectional view of a moving status in the present invention.

FIG. 5 illustrates one embodiment of the present invention.

FIG. 6 illustrates a schematic view of the damping structure in use of the present invention.

FIG. 7 illustrates a partial enlarging view of the damping structure in use of the present invention.

FIG. 8 illustrates an adjusting status of the damping structure in use of the present invention.

FIG. 9 illustrates another view of the damping structure in use of the present invention.

FIG. 10 illustrates another embodiment of the present invention.

FIG. 11 illustrates an exploded view of another embodiment of the present invention.

FIG. 12 illustrates a sectional view of another embodiment of the present invention.

FIG. 13 illustrates a moving status of another embodiment of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

Referring to FIGS. 1 to 4, an electronically controlled damping structure in fitness equipment includes a base (10), an adjusting unit (20) and a driving component (30). The base (10) has a main body (11) having a hollow body (12) extending therefrom. A receiving space (13) is formed inside the hollow body (12) to communicate with the main body (11), and the front portion of the hollow body (12) shrinks and forms a ring stopping portion (131) corresponding to the receiving space (13). The adjusting unit (20) at least has one top unit (21), a buffer unit (22) and a passive component (23) that are disposed orderly in the receiving space (13) of the base (10). The front portion of the top unit (21) is protruding from the opening of the receiving space (13) and the front portion thereof can form a connecting portion (211) (see FIG. 9). The rear end of the top unit (21) is enlarging to have a restricting portion (212) to form a restricting position with the ring stopping portion (131). The passive component (23) has a through hole (231) and the receiving space (13) of the base (10) and the passive component (23) are engaged through threads. The receiving space (13) has an inner thread section (132) from the main body (11) to the middle section of the receiving space (13), and the passive component (23) has an outer thread section corresponding to the receiving space (13). Also, a block (24) is disposed between the passive component (23) and the buffer unit (22) and a through opening (241) is formed at center portion of the block (24). The driving component (30) is disposed at the main body (11) of the base (10) and a locking portion (111) is disposed between the base (10) and the driving component (30). The main body (11) of the base (10) can extend to form the locking portion (111), or one side of the driving component (30) can extend to form the locking portion (111) (see FIG. 5). A driving shaft (31) is protruding from the driving component (30) into the receiving space (13) to link with the through hole (231) of the passive component (23), so the passive component (23) can be driven by the driving component (30) to adjust the movement in the receiving space and form a restricting position. In one embodiment, the driving component is a motor and the driving shaft (31) is not a tubular body, and the through hole (231) of the passive component is a non-circular hole corresponding to the driving shaft (31). Therefore, the passive component (23) can move in the receiving space (13) using the driving component (30) to further adjust the distance between the passive component (23) and the top unit (21) to achieve the goal of adjusting the resilient coefficient of the buffer unit (22). Namely, it achieves the goal of controlling the position of the adjusting components electrically and an electrically controlled damping structure in fitness equipment is obtained.

Referring to FIGS. 2 to 4 and 6, the base (10) is installed on fitness equipment such treadmills, steppers or fitness bicycles and with the resistance provided by the damping structure, the user can exercise thereon. The top unit (21), buffer unit (22), block (24) and passive component (23) of the adjusting unit (20) are orderly disposed into the receiving space (13), and the passive component (23) and the receiving space (13) are conjugated through the inner and outer thread sections (132) (233) respectively. Furthermore, the driving component (30) is disposed into the main body (11) of the base (10), so that the adjusting unit (20) can be restricted in the receiving space (13). The driving shaft (31) is connected with the through hole (231) of the passive component (23), the front end of the top unit (21) is protruding from the opening of the receiving space (13), and the restricting portion (212) and the ring stopping portion (131) of the receiving space (13) are against each other to form a restricted positioning. Therefore, referring to FIGS. 7 and 8, when the user wants to adjust the damping of the fitness equipment, the driving component (30) can be driven electrically and linked with the passive component (23) and the driving shaft (31). Since the driving shaft (31) and the passive component (23) are not tubular and the passive component (23) and the receiving space (13) are engaged with each other through inner and outer thread sections (132) (233), when the passive component (23) is driven by the driving component (30), it moves in the receiving space (13) in a spiral manner and drives the block (24) to move at the same time. Meanwhile, the movement of the passive component (23) can be used to adjust the distance between the passive component (23) and the top unit (21) to further adjust the resilient coefficient of the buffer unit (22) between the passive component (23) and the top unit (21). Thus, when the top unit (21) is protruding from the opening of the receiving space (13) and against the fitness equipment, the resistance is obtained through pushing back the top unit (21).

FIG. 9 shows another embodiment of the present invention. The front portion of the top unit (21) shrinks and is disposed inside the receiving space (13). When the fitness equipment is activated and protruding into the receiving space (13) to contact the top unit (21), the resistance can also be obtained through pushing back the top unit (21).

FIGS. 10 to 13 show an exemplary embodiment of the present invention. The inner wall of the receiving space (13) and the outer wall of the passive component (23) form a sliding surface. One side of the hollow body (12) of the base (10) has a spiral hole (121) and a restricting unit (122) is screwed into the spiral hole (121) and protruding to the inner wall of the receiving space (13). The passive component (23) has a restricting slot (232) corresponding to the restricting unit (122), so that the passive component (23) is restricted in the receiving space (13) through the restricting slot (232) because the restricting unit (122) of the hollow body (12) plugs into the restricting slot (232). The driving shaft (31) of the driving component (30) and the through hole (231) of the passive component (23) are engaged with each other through threads, wherein the driving shaft (31) has outer threads while the through hole (231) of the passive component (23) has inner threads. When the passive component (23) is driven by the driving component (30), the passive component (23) will not be activated to rotate with the driving shaft (31), but will move linearly along the restricting unit (122) through the restricting slot (232) to further adjust the distance between the passive component (23) and the top unit (21), so the buffer unit (22) can be compressed or loosened to achieve the goal of adjusting the resilient coefficient of the buffer unit (22) to obtain the resistance from the fitness equipment.

According to the embodiments described above, the present invention is advantageous because the damping structure can be adjusted electronically, so when the user is exercising on the fitness equipment, he/she does not have to adjust the damping manually to increase the practicability of the fitness equipment, and it is more convenient for the user to adjust the damping.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An electronically controlled damping structure in fitness equipment comprising:
a base, having a main body with a hollow body extending therefrom; and receiving space is formed inside the hollow body to communicate with the main body;
an adjusting unit at least having a top unit, a buffer unit and a passive component that are disposed orderly in the receiving space of the base; and the passive component having a through hole;
a driving component disposed at the main body of the base and having a driving shaft protruding from the driving component into the receiving space to link the through hole of the passive component, so the passive component is driven by the driving component to adjust movement in the receiving space and form a restricting position;
wherein the driving component drives the passive component to move in the receiving space to further adjust the distance between the passive component and the top unit to adjust resilient coefficient of the buffer unit to electrically control the damping structure.

2. The electronically controlled damping structure in fitness equipment of claim 1, wherein one side of the hollow body of the base has a spiral hole (121) and a restricting unit is screwed into the spiral hole and protruding to an inner wall of the receiving space, and the passive component has a restricting slot corresponding to the restricting unit, so when the passive component I driven by the driving component, the passive component moves linearly from the restricting slot along the restricting unit.

3. The electronically controlled damping structure in fitness equipment of claim 1, wherein the driving component is a motor, and the driving shaft of the driving component engages with the passive component through threads; the driving shaft having outer threads while the through hole of the passive component having inner threads.

4. The electronically controlled damping structure in fitness equipment of claim 1, wherein the receiving space has an inner thread section from the main body to a middle section of the receiving space, and the passive component has an outer thread section corresponding to the receiving space, so when the passive component is driven by the driving component, the passive component moves spirally in the receiving space, wherein a block is disposed between the passive component and the buffer unit and a through opening is formed at center portion of the block.

5. The electronically controlled damping structure in fitness equipment of claim 4, wherein the driving component is a motor and the driving shaft is non-circular, and the through opening of the passive component corresponding to the driving shaft is non-circular.

6. The electronically controlled damping structure in fitness equipment of claim 1, wherein front end of the top unit is protruding from an opening of the receiving space.

7. The electronically controlled damping structure in fitness equipment of claim 6, wherein front portion of the hollow body shrinks and forms a ring stopping portion corresponding to the receiving space, and rear end of the top unit is enlarging to have a restricting portion to form a restricting position with the ring stopping portion.

8. The electronically controlled damping structure in fitness equipment of claim 6, wherein front portion of the top unit is protruding from the opening of the receiving space and the front portion thereof forms a connecting portion.

9. The electronically controlled damping structure in fitness equipment of claim 1, wherein the top unit shrinks in the receiving space.

10. The electronically controlled damping structure in fitness equipment of claim 8, wherein the top unit forms the connecting portion.

11. The electronically controlled damping structure in fitness equipment of claim 1, wherein a locking portion is disposed between the base and the driving component.

12. The electronically controlled damping structure in fitness equipment of claim 11, wherein the base extends to form the locking portion.

13. The electronically controlled damping structure in fitness equipment of claim 11, wherein one side of the driving component extends to form the locking portion.
